(19) United States
(12) Patent Application Publication
(10) Pub. No.: US 2026/0364594 A1
(43) Pub. Date: Nov. 19, 2026

(54) LARGE-SCALE CELL CULTURE ROOM HARVEST FLASK

(71) Applicant: CellFabs Inc., Tainan City (TW)

(72) Inventors: Yun-Shu Chiou, Tainan City (TW); Shang-Chih Lin, Tainan City (TW)

(73) Assignee: CellFabs Inc., Tainan City (TW)

(21) Appl. No.: 19/206,618

(22) Filed: May 13, 2025

(51) Int. Cl. B01L 3/00

(52) U.S. Cl. CPC B01L 3/5021; B01L 2300/042; B01L 2300/0832; B01L 2400/0409

(57) ABSTRACT

A cell harvest bottle suitable for large-scale cell culture rooms comprises a cylindrical bottle body, a cap body, and a harvest tube. The bottle body is provided with a first opening and a second opening coaxially aligned at both ends, to which the cap body and the harvest tube are respectively threaded. The cap body includes a window for fluid injection via puncture and is pivotally equipped with a flip-type cover plate near the window, making it suitable for integration with automated filling equipment, thereby effectively minimizing contamination and enhancing aseptic operation efficiency. The harvest tube is equipped with a rotatable valve body, which enables rapid switching between open and closed states after centrifugation to prevent backflow or cross-contamination of the culture fluid. The structural design allows cells to sediment into the harvest tube after centrifugation for independent storage, transfer, or subsequent processing. This facilitates the establishment of a modular and efficient automated cell culture facility with improved productivity and biosafety control.

### BACKGROUND OF THE DISCLOSURE

### 1. Field of the Disclosure

The present invention relates to a cell harvest flask structure, and more particularly to a cell harvest flask suitable for automated control and capable of rapidly separating and harvesting cells in a large-scale cell culture room.

### 2. Description of the Prior Art

Most conventional cell culture flasks integrate the bottle body and the bottom harvest tube through either monolithic molding or adhesive bonding. During large-scale cell cultivation and harvesting, after the cells are separated by centrifugation, it is often not possible to directly detach the cell culture flask for independent preservation or transfer of the harvest liquid containing the target cells at the bottom. Instead, only extraction methods can be used for separate storage. If the entire flask needs to be processed, it will increase the burden of subsequent handling procedures. Furthermore, operations such as cryopreservation, aliquoting, or analysis are also constrained by the volume and structure of the bottle body, leading to decreased operational efficiency and a heightened risk of cross-contamination. Therefore, current structures remain significantly lacking in terms of modularity, separability, and operability.

On the other hand, in automated cell culture systems, the connection and positioning between the cell culture flask and the centrifuge is also a critical issue. Traditional cell culture flask designs do not consider fixation and mounting structures compatible with the centrifuge. The bottle body lacks clearly defined positioning features on its exterior, often requiring additional clamps or manual operations, which can cause wobbling or instability of the bottle body during high-speed centrifugation, thus affecting centrifugation efficiency and cell sedimentation results. With the advancement of automated production technology, more systems are incorporating robotic arms for gripping and operation. However, existing bottle body designs lack standardized interfaces and gripping structures, making it difficult for robotic arms to accurately recognize and grasp them, thereby reducing the flexibility and efficiency of overall process integration.

In addition, regarding the liquid injection design of culture flasks, most current approaches still rely on manually opening the lid via screwing or pulling to fill the culture medium. However, such structures involve cumbersome opening and closing operations and are prone to issues like leakage or dripping of culture liquid when not tightly sealed, thereby compromising the overall sterile environment and product quality. Furthermore, the current cap body designs generally lack automatic flipping and elastic return mechanisms, making them unsuitable for integration with automated feeding devices for aseptic operation. They also cannot directly connect to automatic dispensing pipelines, resulting in insufficient filling efficiency and sealing integrity, which further limits their application in large-scale automated production.

In view of the foregoing, the inventor, drawing upon years of experience in the development, manufacturing, and design of related products, has conducted detailed design and careful evaluation to ultimately achieve the present invention, which is both practical and effective.

### SUMMARY OF THE DISCLOSURE

The technical problem to be solved by the present invention is to address the above-mentioned deficiencies in the prior art by providing a cell harvest bottle for large-scale cell culture facilities.

A bottle body is formed in a cylindrical shape to define a containment space, with a first opening and a second opening in fluid communication with the containment space, wherein the first opening and the second opening are disposed coaxially and oppositely aligned. A first thread is formed at the first opening, and a second thread is formed at the second opening. A cap body is threaded onto the first thread of the bottle body to cover the first opening. The cap body has a window and is provided with a protruding coupling section adjacent to the window, wherein the coupling section is pivotally connected to a cover plate, and the cover plate is configured to pivot toward the containment space. A harvest tube defines a harvest chamber, and one end of the harvest tube is threadedly connected to the second thread, allowing the harvest chamber to communicate with the containment space. A valve body is mounted at a middle section of the harvest tube, and rotation of the valve body switches the communication between the harvest chamber and the containment space to be either connected or isolated.

Wherein an outer surface of the bottle body is formed with a first ring section, and the bottle body is fixed to a centrifuge via the first ring section. The centrifuge spins the bottle body, thereby causing the cells suspended in the bottle body to sediment into the harvest tube.

Wherein a motor shaft is used to drive a support frame inside the centrifuge, and at least one cylinder is suspended from the support frame. The bottle body is inserted through the cylinder and rests with the first ring section abutting an upper edge of the cylinder. When the motor shaft rotates, the cylinder is flung outward, positioning the harvest tube in the centrifugal direction of the bottle body.

Wherein the bottle body forms a second ring section between the first ring section and the first thread, and the space between the first ring section and the second ring section is configured to allow gripping by a robotic arm.

Wherein the cap body is provided with a latch pin passing through the coupling section, and the latch pin also passes through the cover plate. A torsion spring is further mounted on the latch pin, with one end of the torsion spring abutting the cover plate and the other end abutting the coupling section, whereby the elastic force of the torsion spring normally urges the cover plate to close over the window.

Wherein a sealing pad is affixed to the surface of the cover plate, and the sealing pad is pressed against the window to form a leak-proof seal.

Wherein the harvest tube forms a valve chamber, the valve chamber defines a valve opening, and the valve body is housed within the valve chamber as a cylindrical body. The cylindrical body is penetrated by a flow hole, and rotation of the valve body enables the flow hole to communicate with the harvest chamber of the harvest tube.

Wherein the cylindrical body is sleeved with an elastic element, and the elastic element abuts against the inner wall surface of the valve chamber. The cylindrical body is recessed to form at least one flat section, and the inner edge of the elastic element forms a flat contact surface. The flat section and the flat contact surface are in close contact with each other, allowing the valve body and the elastic element to rotate synchronously.

Wherein the cylindrical body is respectively provided with a front stopper and a rear stopper protruding at both ends of the elastic element, the front stopper and rear stopper serve to position and limit the elastic element. Furthermore, the elastic element protrudes outward from the cylindrical body, and the valve chamber is provided with a limiting ring on the inner edge of the valve opening, which blocks the elastic element, thereby achieving a limiting function for the valve body.

Wherein, after the centrifugation process, the harvest tube is sealed by rotating the valve body to temporarily block the harvest chamber. After loosening the second thread and detaching it from the bottle body, a harvest cap is screw-coupled to the harvest tube to seal the harvest tube.

The primary objective of the present invention lies in the detachable harvest tube and valve body switching design. The harvest tube is equipped with the valve body, which can be rotated to switch between a connected or isolated state between the harvest chamber and the containment space, thereby preventing backflow of the culture fluid into the bottle body after centrifugation. This allows the harvest tube to be quickly loosened and detached from the bottle body after cell harvest and independently sealed and stored, improving the convenience and safety of sample preservation. As a result, the bottle body and the harvest tube can be operated separately, effectively reducing the risk of cross-contamination and enhancing the scalability and automation of the cell harvesting process.

The second primary objective of the present invention lies in the centrifugation positioning structure and robotic arm-compatible gripping design. The bottle body is formed with a first ring section and a second ring section on its outer surface. The first ring section is used to secure the bottle body to the edge of a cylinder within the support frame of the centrifuge, ensuring stable positioning during high-speed rotation. The second ring section, in conjunction with the first ring section, defines a space suitable for gripping by a robotic arm, allowing an automated system to perform accurate pick-and-place and transport operations. This design enhances the efficiency of automated system integration and continuous processing.

The third primary objective of the present invention lies in the automatic cap-opening liquid injection design and airtight leak-proof structure. The cap body is equipped with a pivotable cover plate, which, in combination with the torsion spring and sealing pad, normally remains tightly closed over the window. This configuration allows the suction tube to automatically open the cover plate upon insertion and ensures it returns to the closed position afterward, thereby enabling liquid filling without unscrewing the entire cap body. This design significantly simplifies the operational procedure and reduces contamination and leakage risks during the filling process. Furthermore, the sealing pad, disposed on the surface of the cover plate, helps maintain a liquid-tight seal even when the bottle body is inverted or subjected to vibrations, thereby enhancing safety and reliability during production.

Other objects, advantages, and novel features of the present invention will become more apparent from the following detailed description and the accompanying drawings.

### BRIEF DESCRIPTION OF THE DRAWINGS

The present invention will be best understood by referring to the following detailed description of one illustrative embodiment in conjunction with the accompanying drawings, in which

FIG. 1 is a perspective view of the present invention;

FIG. 2 is an exploded perspective view of the present invention;

FIG. 3 is a schematic view illustrating the filling of culture liquid to be harvested in the present invention;

FIG. 4 is a sectional view at the valve body position of the present invention;

FIG. 5 is a schematic view showing the harvest bottle being placed into the centrifuge according to the present invention;

FIG. 6 is an internal perspective view of the centrifuge applied in the present invention;

FIG. 7 is a schematic view of the centrifugation operation in the present invention;

FIG. 8 is a schematic view of the harvest bottle with sedimented cells after centrifugation in the present invention;

FIG. 9 is a schematic view showing the harvest bottle with the valve body closed in the present invention;

FIG. 10 is a schematic view illustrating the separation of the bottle body and the harvest tube in the present invention; and

FIG. 11 is a schematic view showing the harvest tube being capped in the present invention.

### DETAILED DESCRIPTION

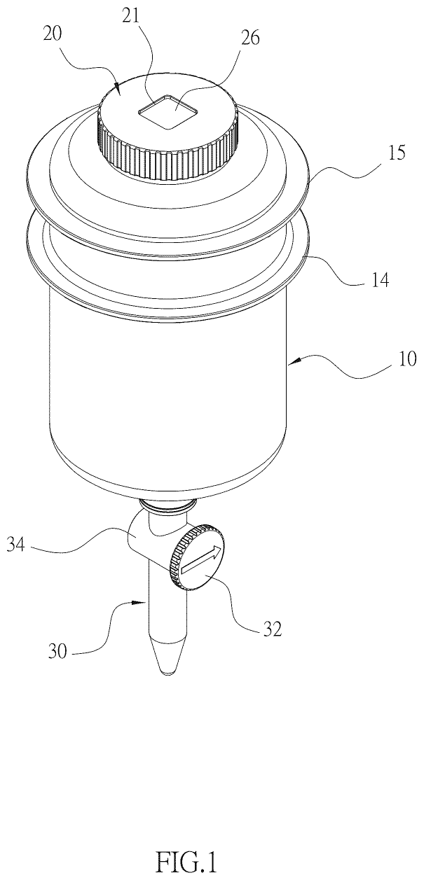

Referring first to FIGS. 1 through 4, a cell harvest bottle for a large-scale automated cell culture facility comprises: a bottle body 10, a cap body 20, and a harvest tube 30. The bottle body 10 is cylindrical and defines a containment space 11. The bottle body 10 forms a first opening 12 and a second opening 13 in communication with the containment space 11, wherein the first opening 12 and the second opening 13 are aligned along a common center axis, which optimizes the cell sedimentation direction during centrifugation. A first thread 121 is formed at the first opening 12, and a second thread 131 is formed at the second opening 13, allowing both secure structural stability and ease of assembly/disassembly.

The cap body 20 is screwed onto the first thread 121 of the bottle body 10, covering the first opening 12. A window 21 is formed in the cap body 20, and a coupling section 22 is protrudingly provided near the window 21. A cover plate 23 is pivotally mounted on the coupling section 22 and is capable of flipping toward the containment space 11. Through this flipping mechanism, a one-way opening function is achieved, improving the convenience and aseptic security of automated filling operations. This design is well-suited for manipulation by robotic arms or automated infusion systems.

The harvest tube 30 defines a harvest chamber 31. One end of the harvest tube 30 is screwed onto the second thread 131, such that the harvest chamber 31 communicates with the containment space 11. A valve body 32 is installed in the middle portion of the harvest tube 30. By rotating the valve body 32, the harvest chamber 31 and the containment space 11 can be selectively connected or isolated. The valve body 32 allows precise switching of the open/close state of the harvest tube 30, thus preventing backflow of culture liquid and reducing contamination risks.

In summary, the bottle body 10 is filled with cell culture liquid to be harvested. After centrifugation, cells settle into the harvest chamber 31 of the harvest tube 30. The valve body 32 is then rotated to block the harvest chamber 31, enabling the harvest tube 30 to be easily detached from the bottle body 10 for independent storage. This separable structure also facilitates subsequent cell recovery, storage, or secondary processing, improving production line efficiency and modular maintenance. The harvest bottle structure provided by this invention supports the establishment of large-scale automated cell culture factories for efficient harvesting of cultured cells.

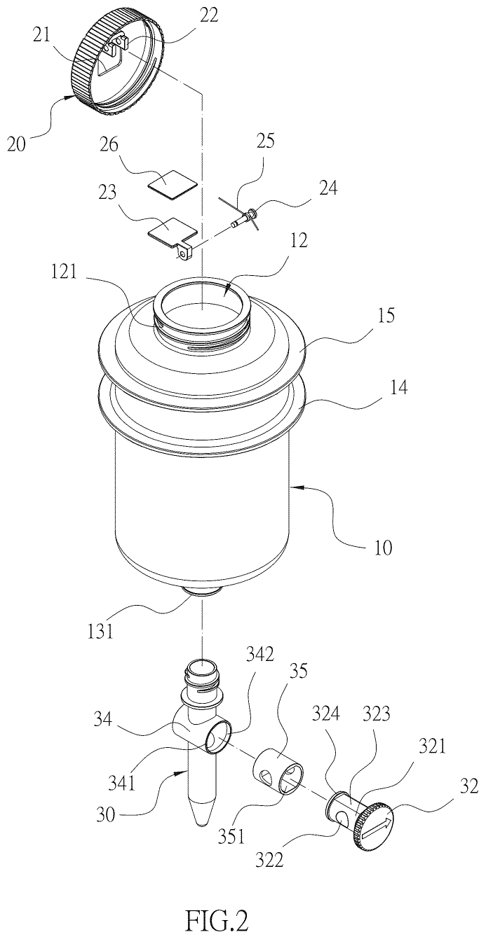

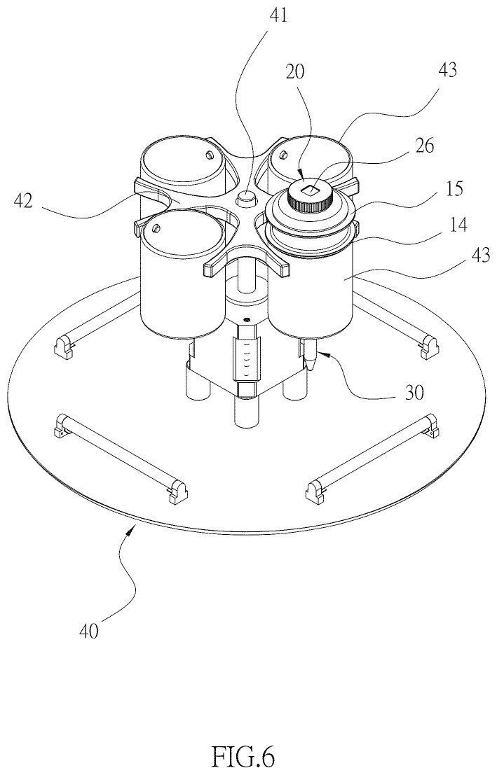

Referring further to FIGS. 2 through 6, the outer surface of the bottle body 10 is formed with a first ring section 14, which is used to secure the bottle body 10 within a centrifuge 40. The first ring section 14 may be configured as an annular protruding structure to provide a stable loading reference surface. The centrifuge 40 spins the bottle body 10, causing the suspended cells within the bottle body 10 to settle into the harvest tube 30, thereby achieving separation of cells from the culture liquid.

Inside the centrifuge 40, a motor shaft 41 drives a support frame 42, and at least one cylinder 43 is suspended from the support frame 42. The bottle body 10 is inserted into the cylinder 43, with the first ring section 14 abutting against the upper edge of the cylinder 43. Rotation of the motor shaft 41 causes the cylinder 43 to be flung outward. The cylinder 43 may include receiving and limiting structures to prevent the bottle body 10 from shaking or shifting. At this point, the harvest tube 30 is aligned in the centrifugal direction of the bottle body 10.

Between the first ring section 14 and the first thread 121 on the bottle body 10, a second ring section 15 is formed, which may also be an annular protruding structure. The space between the first ring section 14 and the second ring section 15 is configured for robotic arm gripping and enhances the stability of mechanical gripping during handling.

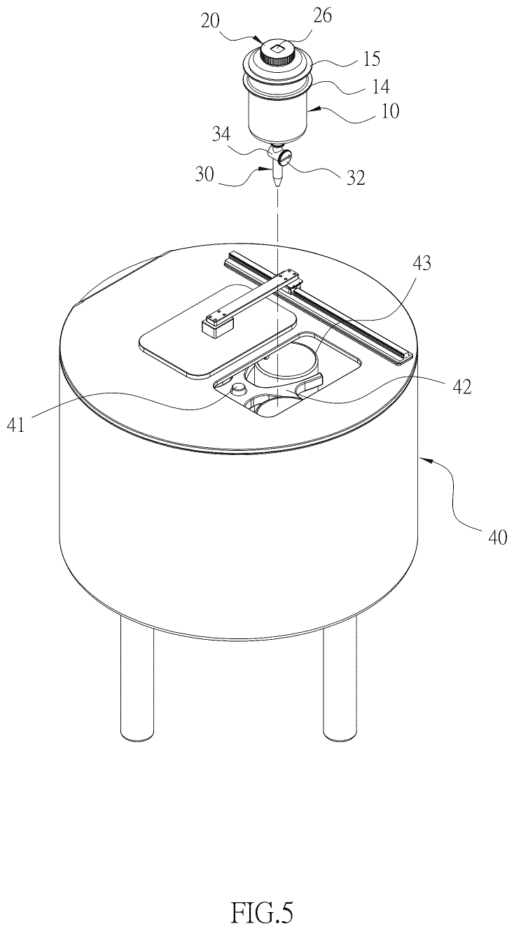

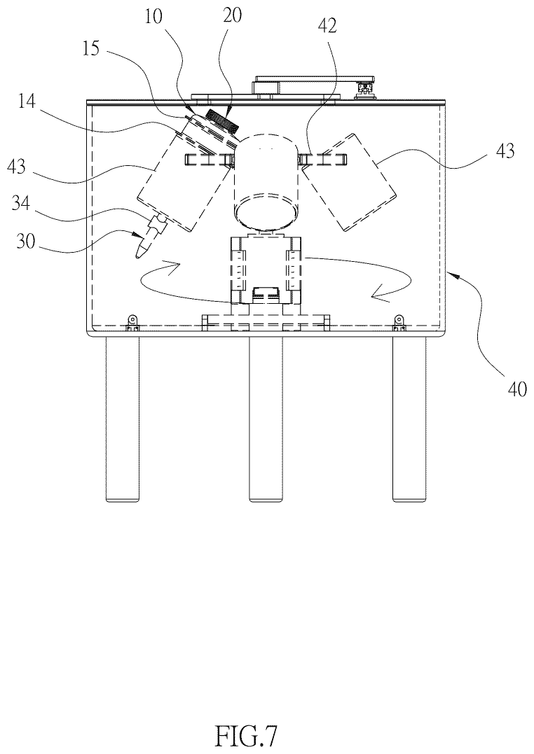

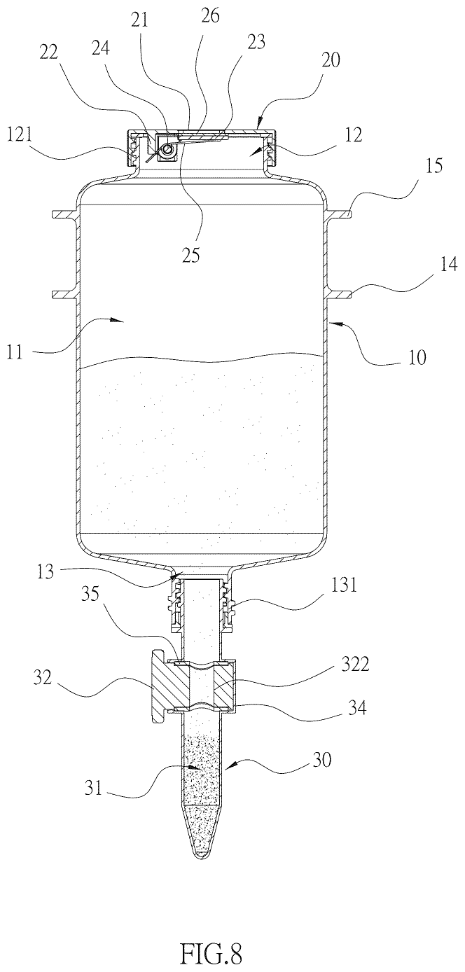

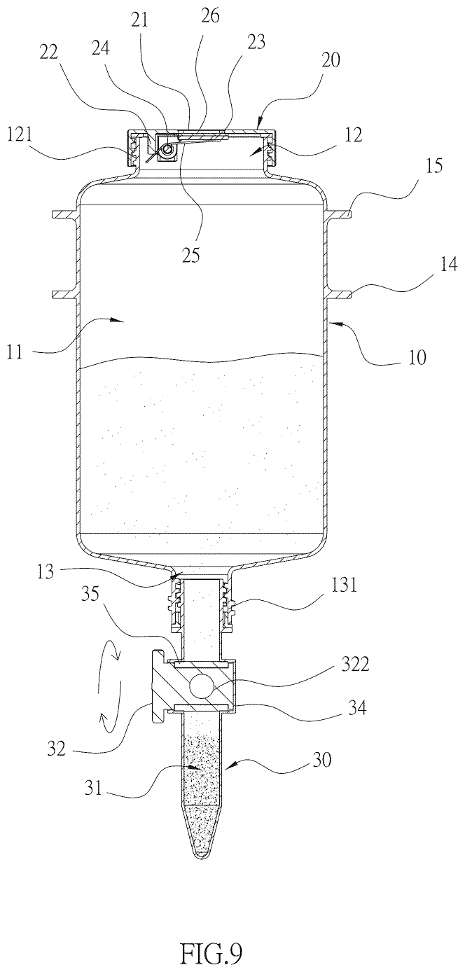

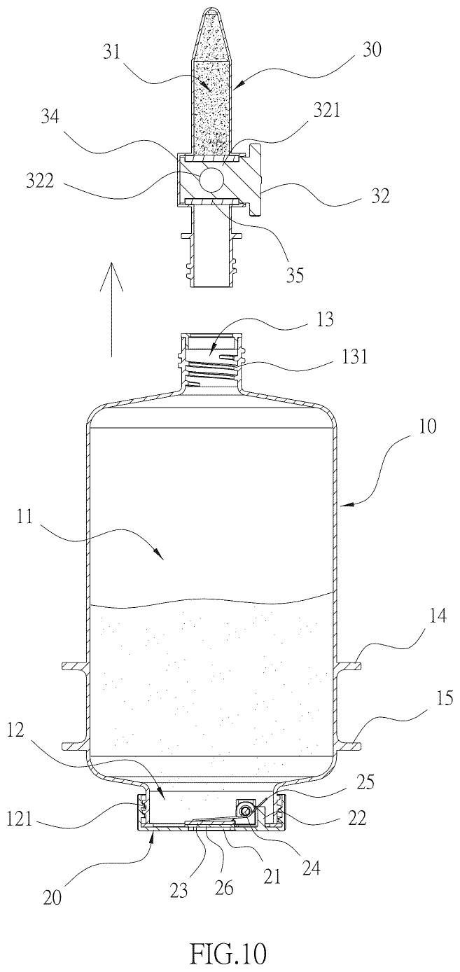

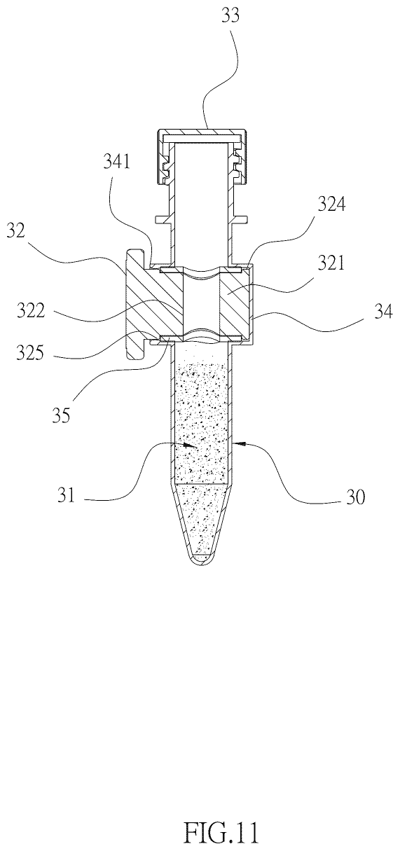

For the actual harvesting steps, as shown in FIGS. 5 through 11, cells are cultivated in suspension in a high-throughput automated process. Upon determining that harvesting is appropriate, culture liquid is extracted using a suction tube 16, which is moved above the bottle body 10. The suction tube 16 presses downward to directly push open the cover plate 23 and enter the interior of the bottle body 10, allowing the bottle body 10 to be filled with the cell culture liquid to be harvested.

Next, the bottle body 10 is placed into the centrifuge 40, with the bottle body 10 secured in position within the cylinder 43. The motor shaft 41 then drives the rotation of the support frame 42 and the cylinder 43. The bottle body 10 is flung outward by centrifugal force. The centrifugation speed can be adjusted according to the cell type to effectively enhance sedimentation efficiency. The centrifugal force also pushes the cells toward the end of the harvest tube 30, causing them to collect within the harvest chamber 31 of the harvest tube 30.

After centrifugation, the valve body 32 of the harvest tube 30 is rotated to temporarily block the harvest chamber 31, preventing liquid in the harvest tube 30 from flowing back into the bottle body 10. The harvest tube 30 is then unscrewed from the second thread 131 and detached from the bottle body 10. A harvest cap 33 is then screwed onto the harvest tube 30 to seal it. This ensures the secure sealing and preservation of the harvested sample, supporting subsequent refrigeration, transport, or analytical procedures.

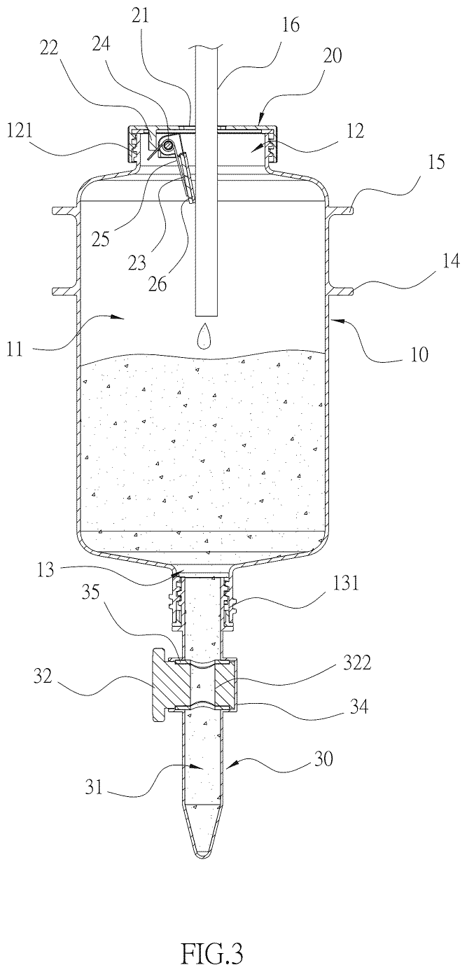

As shown in FIGS. 2 and 3, the cap body 20 is provided with a latch pin 24 that passes through the coupling section 22 and also extends through the cover plate 23. The latch pin 24 may be made of stainless steel or biocompatible plastic material to ensure long-term operational stability and chemical resistance. Additionally, a torsion spring 25 is installed along the latch pin 24. One end of the torsion spring 25 is pressed against the cover plate 23, and the other end is pressed against the coupling section 22. The elastic force of the torsion spring 25 enables the cover plate 23 to normally remain closed over the window 21 of the cap body 20. When the cover plate 23 automatically springs back into the closed position due to the torsion spring 25, it remains tightly sealed, allowing culture liquid to be filled without loosening the cap body 20, while effectively preventing leakage of the culture medium. The surface of the cover plate 23 is fitted with a sealing pad 26, which presses against the window 21 to further enhance the leak-proof performance between the cover plate 23 and the cap body 20. The sealing pad 26 may be made of silicone or PTFE material, providing high temperature resistance, chemical resistance, and excellent sealing performance. This design ensures that the culture liquid does not leak from the cover plate 23 even when the bottle body 10 is inverted, thereby improving overall user convenience.

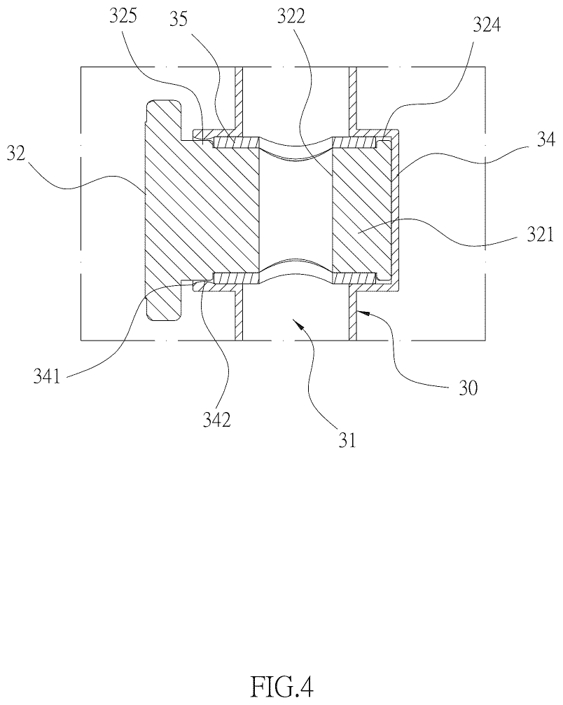

As further illustrated in FIGS. 2 and 4, the harvest tube 30 defines a valve chamber 34, which is formed with a valve opening 341. The valve body 32, in the form of a cylindrical body 321, is received within the valve chamber 34. The cylindrical body 321 is provided with a through flow hole 322. By rotating the valve body 32, the flow hole 322 can be aligned to communicate with the harvest chamber 31 of the harvest tube 30, thereby allowing culture liquid to flow into the harvest tube 30. Conversely, the valve body 32 can be rotated to block the flow of the culture liquid out of the harvest tube 30. The cylindrical body 321 is sleeved with an elastic element 35, which is pressed against the inner wall surface of the valve chamber 34. The elastic element 35 may be a sleeve-type elastic gasket, providing a liquid-tight sealing function. The cylindrical body 321 is recessed to form at least one flat section 323, while the inner edge of the elastic element 35 is formed with a flat contact surface 351. The flat section 323 and the flat contact surface 351 are in close contact with each other, allowing the valve body 32 and the elastic element 35 to rotate synchronously. Both ends of the cylindrical body 321, at the respective ends of the elastic element 35, are provided with a front stopper 324 and a rear stopper 325, which serve to restrict the axial displacement of the elastic element 35 and prevent it from slipping or detaching during rotation. Moreover, the elastic element 35 protrudes outward from the cylindrical body 321, and the valve chamber 34 is formed with a limiting ring 342 along the inner edge of the valve opening 341. This limiting ring 342 blocks the elastic element 35, thereby achieving a limiting effect on the valve body 32, ensuring stable operation and preventing over-rotation that could cause structural damage or sealing failure.

The above description represents merely a preferred embodiment of the present invention and should not be construed as limiting the scope of implementation of the invention. Any equivalent changes or modifications made in accordance with the claims of the present invention shall fall within the scope of the patent protection of the present invention.

What is claimed is:

1. A cell harvest bottle for large-scale cell culture rooms includes:
a bottle body, which is formed in a cylindrical shape and defines a containment space, wherein the bottle body forms a first opening and a second opening that communicate with the containment space, and the first opening and the second opening are coaxially aligned with each other; a first thread is formed at the first opening, and a second thread is formed at the second opening;
a cap body, which is screwed onto the first thread of the bottle body to cover the first opening, and the cap body has a window formed thereon; a coupling section protrudes near the window, and a cover plate is pivotally mounted to the coupling section, the cover plate being capable of flipping toward the containment space;
and a harvest tube, which defines a harvest chamber, one end of the harvest tube being screwed onto the second thread so that the harvest chamber communicates with the containment space, and a valve body is installed at a midsection of the harvest tube, wherein rotation of the valve body toggles between communication and isolation of the harvest chamber and the containment space.

2. The cell harvest bottle for large-scale cell culture rooms according to claim 1, wherein a first ring section is formed on the outer surface of the bottle body, and the bottle body is fixed to a centrifuge by the first ring section, such that when the centrifuge spins the bottle body, cells suspended in the bottle body are deposited into the harvest tube.

3. The cell harvest bottle for large-scale cell culture rooms according to claim 2, wherein the centrifuge is internally driven by a motor shaft which actuates a support frame, and at least one cylinder is suspended from the support frame; the bottle body is inserted through the cylinder and rests against the upper edge of the cylinder via the first ring section. When the motor shaft rotates, the cylinder is swung outward, positioning the harvest tube in the centrifugal direction of the bottle body.

4. The cell harvest bottle for large-scale cell culture rooms according to claim 2, wherein a second ring section is formed on the outer surface of the bottle body between the first ring section and the first thread, and a space is defined between the first ring section and the second ring section for gripping by a robotic arm.

5. The cell harvest bottle for large-scale cell culture rooms according to claim 1, wherein the cap body has a latch pin inserted through the coupling section and also through the cover plate, and a torsion spring is further mounted on the latch pin, with one end of the torsion spring pressing against the cover plate and the other end pressing against the coupling section, whereby the restoring force of the torsion spring keeps the cover plate normally closed over the window.

6. The cell harvest bottle for large-scale cell culture rooms according to claim 5, wherein a sealing pad is affixed to the surface of the cover plate, and the sealing pad is pressed against the window to provide a leak-proof sealing effect.

7. The cell harvest bottle for large-scale cell culture rooms according to claim 1, wherein the harvest tube is formed with a valve chamber, the valve chamber having a valve opening, and the valve body is accommodated in the valve chamber as a cylindrical body, wherein the cylindrical body is penetrated by a flow hole, and rotation of the valve body enables the flow hole to be in communication with the harvest chamber of the harvest tube.

8. The cell harvest bottle for large-scale cell culture rooms according to claim 7, wherein the cylindrical body is sleeved with an elastic element, and the elastic element is pressed against the inner wall surface of the valve chamber, wherein the cylindrical body is recessed to form at least one flat section, and the inner edge of the elastic element forms a flat contact surface, and the flat section and the flat contact surface are in close contact with each other, enabling the valve body and the elastic element to rotate synchronously.

9. The cell harvest bottle for large-scale cell culture rooms according to claim 8, wherein the cylindrical body is respectively provided with a front stopper and a rear stopper protruding from both ends of the elastic element, the front stopper and rear stopper serving to limit the elastic element; the elastic element protrudes outward from the cylindrical body, and a limiting ring is formed on the inner edge of the valve opening of the valve chamber, such that the limiting ring blocks the elastic element, thereby providing a limiting function to the valve body.

10. The cell harvest bottle for large-scale cell culture rooms according to claim 1, wherein after centrifugation, the harvest tube is rotated to actuate the valve body to temporarily block the harvest chamber, and after unscrewing from the second thread to detach from the bottle body, a harvest cap is screwed onto the harvest tube, thereby sealing the harvest tube with the harvest cap.
